(19) United States
(12) Patent Application Publication
(10) Pub. No.: US 2025/0227544 A1
(43) Pub. Date: Jul. 10, 2025

(54) METHODS AND MODULES FOR QUALITY OF SERVICE PROVISIONING IN LINK ADAPTATION

(71) Applicants: HUAWEI TECHNOLOGIES CO., LTD., Shenzhen (CN); The University of Western Ontario, London (CA)

(72) Inventors: Jiyang Bai, London (CA); Xianbin Wang, London (CA); Jung Hoon Suh, Kanata (CA); Yan Xin, Kanata (CA); Osama Aboul-Magd, Kanata (CA); Kwok Shum Au, Kanata (CA)

(21) Appl. No.: 18/405,181

(22) Filed: Jan. 5, 2024

(51) Int. Cl. H04W 28/02; H04L 1/00; H04W 28/04; H04W 84/12

(52) U.S. Cl. CPC H04W 28/0273; H04L 1/0003; H04W 28/04; H04W 84/12

(57) ABSTRACT

The present disclosure relates to methods and modules for link adaptation in a network system comprising an access point (AP) linked to one or more stations through one or more links. The stations generate a set of quality of service provisioning link adaptation (QPLA) parameters, which comprise a data rate requirement, a packet error rate (PER) requirement, and a performance preference. The AP receives the QPLA parameters and determines link adaptation for each of the one or more stations based on the QPLA parameters.

### TECHNICAL FIELD

The present disclosure relates generally to methods and modules for managing quality of service for wireless networks, and in particular, to methods and modules using link adaptation.

### BACKGROUND

In wireless networking communications, link adaptation is for dynamically adjusting modulation and coding schemes (MCS) mechanisms to achieve required or desired quality of service (QoS) requirements, which may include data rate throughput, packet error rate (PER) and latency, based on channel state information (CSI) and signal-noise ratios (SNR). Link adaptation currently used in Wi-Fi® systems generally require transmitters to maintain fixed levels of PER while maximizing throughput. Wi-Fi® systems may be used in environments or systems that simultaneously support high data rate throughput applications, such as augmented reality, virtual reality and mixed reality, and low PER applications, such as Industry 4.0™ as well as atypical applications such as normal sensing or integrated sensing and communications. Such environments or systems with varied applications results in diverse and application-specific combinations of QoS requirements for link adaptation. There remains a need to improved methods and systems to meet QoS requirements in systems having diverse applications.

### SUMMARY

Systems supporting a wide variety of emerging applications results in a diverse and application-specific combination of QoS requirements. To support such QoS requirements, improved link adaptation mechanisms may be required, such as for Wi-Fi® access points, to integrate station-specific QoS requirements with QoS prioritizations from different application scenarios. In existing systems, link adaptation may focus on maintaining a fixed level of PER while maximizing data rate. This may not be suitable to address varied and diverse QoS requirement combinations, such as but not limited to, data rate throughput, PER, bit error rate, latency, and/or the like.

The present disclosure relates to methods and modules wherein stations provide a set of QoS link adaptation (QPLA) parameters, which comprises a data rate requirement, PER requirement, and a preference. The preference provides an indication of the relative importance or preference between data rate and PER. An access point (AP) may use the QPLA parameters provided by one or more stations to provide link adaptations for each station that is suitable to their requirements.

In a broad aspect of the present disclosure, a method comprises a method for link adaptation in a network system comprising an access point linked to one or more stations through one or more links, the method comprising: receiving QPLA parameters from the one or more stations, the QPLA parameters comprising a data rate requirement, a PER requirement, and a performance preference; determining a link adaptation for the one or more stations based on the QPLA parameters; and setting the link adaptation for the one or more stations.

In some embodiments, the method further comprising requesting the QPLA parameters from the one or more stations.

In some embodiments, the performance preference comprises a data rate preference and a PER preference.

In some embodiments, the link adaptation comprises a modulation and coding scheme and a number of space time streams.

In some embodiments, the method further comprises assigning a conventional link adaptation for one or more stations not having provided QPLA parameters.

In some embodiments, the link adaptation is for a wireless local area network basic service set.

In some embodiments, the link adaptation is for an 802.11 protocol.

In another broad aspect of the present disclosure, a method for link adaptation in a network system comprises an access point linked to one or more stations through one or more links, the method comprising: determining QPLA parameters comprising a data rate requirement, a PER requirement, and a performance preference; and transmitting the QPLA parameters to an access point.

In some embodiments, the method further comprises receiving a request from the access point for the QPLA parameters.

In some embodiments, the performance preference comprises a data rate preference and a PER preference.

In some embodiments, the QPLA parameters are generated from information in a higher layer.

In some embodiments, the link adaptation is for a wireless local area network basic service set.

In some embodiments, the link adaptation is for an 802.11 protocol.

In another broad aspect of the present disclosure, a module for link adaptation in a network system comprises an access point linked to one or more stations through one or more links, the module comprising: a transceiver for sending and receiving signals from one or more stations; a controller for: receiving QPLA parameters from the one or more stations, the QPLA parameters comprising a data rate requirement, a PER requirement, and a performance preference; determining a link adaptation for the one or more stations based on the QPLA parameters; and setting the link adaptation for the one or more stations.

In some embodiments, the module is further for requesting the QPLA parameters from the one or more stations.

In some embodiments, the performance preference comprises a data rate preference and a PER preference.

In some embodiments, the link adaptation comprises a modulation and coding scheme and a number of space time streams.

In some embodiments, the module is further for assigning a conventional link adaptation for one or more stations not having provided QPLA parameters.

In some embodiments, the link adaptation is for a wireless local area network basic service set.

In some embodiments, the link adaptation is for an 802.11 protocol.

### BRIEF DESCRIPTION OF THE DRAWINGS

For a more complete understanding of the disclosure, reference is made to the following description and accompanying drawings, in which:

FIG. 1 is a schematic of an exemplary embodiment of an operating environment;

FIG. 2 is a schematic of an exemplary embodiment of a downlink multi-user transmission process;

FIG. 3 is a flowchart of an exemplary embodiment of a process at an access point;

FIG. 4 is a flowchart of an exemplary embodiment of a process at a station;

FIG. 5 is an illustration of a control subfield in a high-efficiency control variant frame;

FIG. 6 is an illustration of a QPLA control subfield in a high-efficiency control variant frame;

FIG. 7 is a flowchart of a method at an AP of an embodiment of the present disclosure; and

FIG. 8 is a flowchart of a method at a station of an embodiment of the present disclosure.

### DETAILED DESCRIPTION

Unless otherwise defined, all technical and scientific terms used herein generally have the same meaning as commonly understood by one of ordinary skill in the art to which this disclosure pertains. Exemplary terms are defined below for ease in understanding the subject matter of the present disclosure.

In embodiments disclosed herein, an access point (AP) or wireless AP is a device which acts a portal to other devices to connect to one or more other networks. In some embodiments, the AP provides an interconnection between wireless devices and other wireless/wired networks including the devices thereon. APs are commonly used for extending wireless coverage of an existing network and for increasing the number of users or devices that can connect to a wireless local area network (WLAN).

In embodiments disclosed herein, a station (STA) is a device configured to connect to others STAs and/or one or more APs. A STA may be fixed, mobile or portable. A STA may also be referred to as a wireless client, a node, and/or a transmitter or receiver based on transmission characteristics.

The Institute of Electrical and Electronics Engineers (IEEE) is a professional association for electronic and electrical engineering, and is a body responsible for setting communication standards. The IEEE 802.11 standards are a part of IEEE 802 local area network technical standards specifying media access control (MAC) and physical layer (PHY) protocols for implementing WLANs. IEEE 802.11-2020 specifies that a STA is any device that contains an IEEE 802.11-conformant MAC and PHY interface for connecting to a wireless medium.

In embodiments disclosed herein, a network comprises two or more devices that are interconnected through a communication link (by a cable, a wireless connection and/or other means) for sharing resources, information, and/or the like. In embodiments disclosed herein, a module is a device that connects to one or more devices through two or more communication links.

Embodiments disclosed herein relate to modules, systems and methods, including circuitry and software for executing processes. As will be described later in more detail, a “module” is a term of explanation referring to a hardware structure such as a circuitry implemented using technologies such as electrical and/or optical technologies (and with more specific examples of semiconductors) for performing defined operations or processes.

A “module” may alternatively refer to the combination of a hardware structure and a software structure, wherein the hardware structure may be implemented using technologies such as electrical and/or optical technologies (and with more specific examples of semiconductors) in a general manner for performing defined operations or processes according to the software structure in the form of a set of instructions stored in one or more non-transitory, computer-readable storage devices or media.

A device, system or module may be referred to as initiating where it initiates a communication configuration, operation, process, sequence, and/or the like. A device, system or module may be referred to as responding where it receives the message, signal, instruction, and/or the like from the initiating device, system or module for communication.

As will be described in more detail below, a module may be a part of a device, an apparatus, a system, and/or the like, wherein the module may be coupled to or integrated with other parts of the device, apparatus, or system such that the combination thereof forms the device, apparatus, or system.

The module executes processes including those for communications. Herein, a process has a general meaning equivalent to that of a method, and does not necessarily correspond to the concept of computing process (which is the instance of a computer program being executed). More specifically, a process herein is a defined method implemented using hardware components for processing data (for example, transmitting and receiving management frames, and/or the like). A process may comprise or use one or more functions for processing data as designed. Herein, a function is a defined sub-process or sub-method for computing, calculating, or otherwise processing input data in a defined manner and generating or otherwise producing output data.

As those skilled in the art will appreciate, the processes disclosed herein may be implemented as one or more software and/or firmware programs having necessary computer-executable code or instructions and stored in one or more non-transitory computer-readable storage devices or media which may be any volatile and/or non-volatile, non-removable or removable storage devices such as random access memory (RAM), read-only memory (ROM), electrically-erasable programmable read-only memory (EEPROM), field programmable gate array (FPGA), solid-state memory devices, hard disks, compact discs (CDs), digital video discs (DVDs), flash memory devices, and/or the like. The module or MLD module may read the computer-executable code from the storage devices and execute the computer-executable code to perform the encryption and/or decryption processes.

Alternatively, the modules or processes disclosed herein may be implemented as one or more hardware structures having necessary electrical and/or optical components, circuits, logic gates, integrated circuit (IC) chips, and/or the like.

In wireless networking communications, link adaptation may be used to dynamically adjust modulation and coding schemes (MCS) mechanisms in order to achieve desired or required quality of service (QoS) requirements, which may include data rate throughput, packet error rate (PER) and latency, based on channel state information (CSI) and signal-noise ratios (SNR). Existing methods and mechanisms of link adaptation generally require transmitters to maintain a level of PER at or below a specified level while maximizing data rate throughput. This approach may be suitable for systems and applications comprising devices having similar data rate throughput and PER requirements. However, for systems and applications comprising diverse and varied data rate throughput and PER requirements, existing methods and mechanisms of link adaptation may not provide degrees of freedom to adequately meets requirements for systems and applications comprising diverse and varied data rate throughput and PER requirements. This may be the result of not being able to properly configuring and adjusting modulation and coding schemes for systems and applications having multiple combinations of QoS requirements. Examples of numerical results illustrating requirement mismatching are provided herein.

Methods and modules provided herein provide one or more additional degrees of freedom in configuring and adjusting modulation and coding schemes for link adaptation to address systems and applications having diverse and varied QoS requirements. Introducing additional variables or parameters to link adaptation configuration and adjustment may provide the necessary additional degrees of freedom for systems and applications having diverse and varied QoS requirements, but may also increase computation complexity of link adaptation.

The adjustment of link adaptation in real-time requires channel state information and high computational complexity may result in adjustment delay and performance degradation. Existing link adaptation methods and systems may attempt to simplify variables by reducing the ability to comprehensively and accurately represent combinations of QoS requirements.

In some embodiments of the present disclosure, QoS provisioning of link adaptation (QPLA) comprises a utility method to replace other evaluation methods for meeting QoS requirements with diverse and varied link adaptation requirements. The use of a utility method provides more flexible adjustment for link adaptation, which is suitable for systems and applications having diverse and varied QoS requirements, such as those comprising a large number of internet of things (IoT) devices or modules. Further, some embodiments of the present disclosure are also suitable for systems and applications comprising generally heterogeneous QoS requirements as the methods of QPLA may reduce potential high computational complexity during operation and may not affect priority design of services in the system or application.

In some embodiments of the present disclosure, QPLA parameters are used for link adaptation and may comprise a normalized weight for QoS provisioning indexing to accommodate the data rate and PER requirements of systems and applications having diverse and varied services and/or needs. This method quantifies and normalizes provisioning of each of the QoS requirements using QoS provisioning indices, weights for each QoS provisioning index by normalizing the QoS weight for each QoS requirement, and linearly sums the QoS provisioning index weighted by normalized QoS weight as the utility function for each service.

Data rate and PER may be configured and adjusted by varying the modulation and coding scheme as well as the number of space time streams. Data rate (DRₙ) and PERₙ may be represented as follows:

DRₙ(MCS, NSTS),

PERₙ(MCS, NSTS)

Stations of modules and devices may have different priorities of data rate and PER requirements, which may be provided by the module or device to the AP. With this priority information, where performance trade-offs may be required, the AP may be able to more appropriately prioritize the parameter having a higher priority to a station at the cost of reducing performance of the lower priority of the station.

In some embodiments of the present disclosure, methods and modules comprising QPLA may comprise the following QPLA parameters: data rate requirement D̅R̅ₙ̅, PER requirement P̅E̅R̅ₙ̅, and weights of PER provisioning index βₙ. The data rate requirement and the PER requirement may be representative of a target data rate and a target PER of a station. The weight of the PER provisioning index is indicative of the preference of PER of a station, wherein a higher value means the PER requirement is more important than the data rate throughput requirement. Conversely, a lower value of the weight of the PER provisioning index is indicative that the PER requirement is less important than the data rate throughput requirement.

Upon receiving a set of QPLA parameters, comprising a data rate throughput requirement Data Rate requirement D̅R̅ₙ̅, PER requirement P̅E̅R̅ₙ̅, and Preference of PER βₙ, by a module or device, such as an AP, the module may use the QPLA parameters to determine a link adaptation scheme to satisfity the QoS requests of the stations. The QPLA may comprise a utility method for each station that considers the diverse and varied data rate and PER requirement of stations and provides a unified link adapation configuration.

To provide a unified configuration for diverse and varied data rate and PER requirements, expressions aₙ and bₙ may indicate if DR, PER requirements are satisfied or not. These may be determined from QoS provisioning indices for data rate and PER, where φ(1)ₙ, φ(2)ₙ∈{0,1}. Normalized QoS weights, expressions αₙ, βₙ may indicate user preferences for data rate and PER, αₙ, βₙε[0,1], αₙ+βₙ=1.

The utility method a station n may be represented by uₙ, which comprises the expression uₙ=αₙ*φ(1)ₙ+βₙ*φ(1)ₙ. The AP may act as a network manager for maximizing the utility of all stations within a particular diverse and varied system. Therefore, QPLA optimization may be expressed as:

$$𝒫 1 : {max}_{MCS , NSTS} {\sum }_{n = 1}^{N} ( {α}_{n} * {φ ( 1 )}_{n} + {β}_{n} * {φ ( 2 )}_{n} )$$

$${α}_{n} + {β}_{n} = 1 ,$$

$${φ ( 1 )}_{n} = \{ \begin{matrix}1 , {DR}_{n} ( MCS , NSTS ) \geq \overline{{DR}_{n}} \\ 0 , otherwise\end{matrix} ,$$

$${φ ( 2 )}_{n} = \{ \begin{matrix}1 , {PER}_{n} ( MCS , NSTS ) \leq \overline{{PER}_{n}} \\ 0 , otherwise\end{matrix} ,$$

where MCS is the modulation and coding scheme and NSTS is the number of space time streams, and γₙ^{k} is the signal-to-noise ratio.

Using the methods and modules described in some embodiments herein, link adaptation may be optimized and an AP effectively satisfy diverse and varied QoS requirements of modules, devices, and/or applications in a system or application.

A process of a QPLA method, module, mechanism, and/or the link may begin with an AP initializing the process to solicit the QPLA requirements from stations. Next, stations may generate QPLA parameters representing QPLA requirements, the QPLA parameters comprising data rate requirements, PER requirement, weights representing parameter preferences. The QPLA parameters may be sent back to the AP, such as feedback in QPLA information fields. The AP may determine the modulation and coding schemes of the stations based on optimized modulation and coding scheme selection from the QPLA parameters as expressed by [symbol] 1 above.

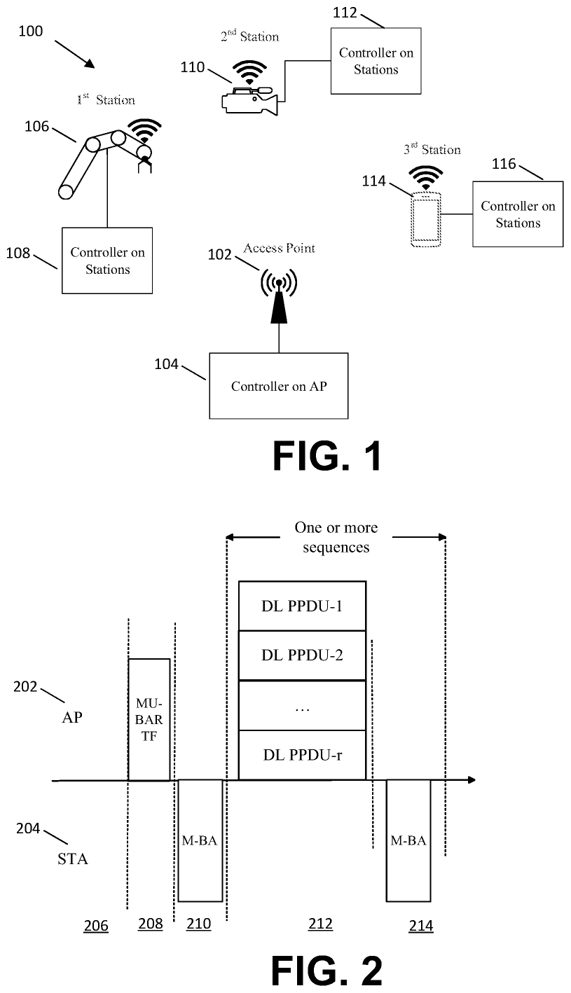

Referring to FIG. 1, a system 100 or operation environment for operation using the QPLA described herein may comprising access points and stations. The system 100 may provide an operating environment such as a wireless local area network (WLAN) basic service set (BSS) and may comprise an AP 102, a first station 106, a second station 110 and a third station 114. The AP 102 may comprise an AP controller 104, the first station 106 may comprise a first station controller 108, the second station 110 may comprise a second station controller 112, and the third station 114 may comprise a third station controller. The AP may implement IEEE 802.11 specification, for example.

The AP 102 may wirelessly communicate with the first station 106, the second station 110, and the third station 114. While FIG. 1 illustrates one AP and three stations, the number of APs and stations may be increased or decreased to any number for any particular application. Each station 106, 110 and 114 may be controlled by an associated controller 108, 112 and 116, which controllers 108, 112 and 116 may be for determining when a station may transmit and/or receive information from the AP 102. This access may also be referred to as channel access. The AP 102 may communicate with the stations 106, 110 and 114. This may comprise broadcasting information to stations 106, 110 and 114 or point-to-point communication with a particular station 106, 110 and 114 by allocating a channel for each station 106, 110 and 114.

Communication between the AP 102 and the stations 106, 110 and 114 may be bi-directional with either the AP 102 acting as transmitter and the stations 106, 110 and 114 acting as receivers, or alternatively, the stations 106, 110 and 114 acting as transmitters and the AP 102 acting as receiver. In communication between AP 102 and stations 106, 110 and 114, the transmitter, which is the sender of information, may adjust the modulation and coding scheme to balance the data rate and packet error rate, according to the request from the receiver, which is the recipient of the information. Therefore, before data transmission, either uplink transmission from a station 106, 110 and 114 to the AP 102 or downlink transmission form the AP 102 to the stations 106, 110 and 114, the transmitter should solicit the requests from receivers, and receivers should send their link adaptation requests to facilitate transmitter to decide the modulation and coding scheme.

Referring to FIG. 2, an exemplary of multi-user downlink data transmission 200 between an AP 202 and one or more stations 204 is illustrated. First, at step 206, non-packet data is transmitted and channel state information is reported. At step 208, a multi-user block-acknowledgement request (MU-BAR) trigger frame (TF) is transmitted to solicit QPLA parameters. At step 210, a multi-user block-acknowledgment (M-BA) is transmitted comprising QPLA parameters from controllers on the one or more stations 204. At step 212, downlink multi-user PHY protocol data units (DL MU PPDU) are transmitted for data transmission. At step 214, a multi-user block-acknowledgment (M-BA) is transmitted to confirm receipt of a data frame.

For multi-user downlink data transmission, the downlink transmissions may be initialed at steps 206 and 208, and steps 212 and 214 may be repeated for continuous downlink transmission.

The AP 202 may obtain channel state information prior to transmission begins through non-packet data at step 206. The AP 202 may include a QPLA solicit request in a high-efficiency variant of a MU-BAR trigger frame at step 208 or a downlink data frame at step 212. The one or more stations 204 may generate QPLA request parameters using controllers associated with the one or more stations 204. The one or more stations 204 may also report QPLA parameter requests in the high-efficiency variation of M-BA at step 210 or step 214. The AP 202 may determine the modulation and coding scheme of the downlink data frame at step 212 using the controller of the AP 202.

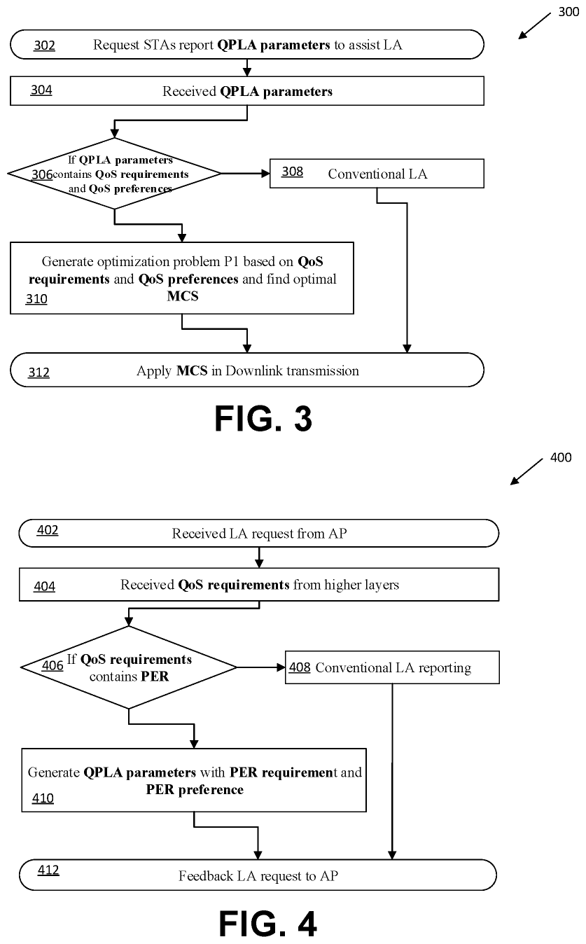

FIG. 3 illustrates an exemplary sequence of steps 300 occurring at an AP, which may be performed by a controller associated with the AP, wherein the AP may generate the QPLA solicit request and send the request to one or more stations to report QPLA parameters to assist link adaptation at step 302. When the AP receives feedback from one or more stations at step 304, the AP evaluates whether the QPLA parameters reported by each of the one or more stations comprise QoS requirements and QoS preferences at step 306. At step 310, the AP uses the QPLA parameters provided to generated link adaptations for the stations for the stations who reported QPLA parameters, and, at step 312, adjusts the link adaptation based on these utility functions. At step 308, the AP will use conventional link adaptations for those stations who did not report QPLA parameters.

FIG. 4 illustrates an exemplary sequence of steps 400 occurring at one or more stations, which may be performed by a controller associated with the one or more stations, wherein the one or more stations may generate a data rate requirement D̅R̅ₙ̅, PER requirement P̅E̅R̅ₙ̅, and Preference of PER βₙ, at step 410 according to the service requirements from a higher layer obtained at step 404. At step 402, when a station receives a QPLA solicit request from an AP, the station obtains service requirements from the higher layer at step 404 and checks if the QoS parameters comprise a PER at step 406. Data rate requirements, PER requirements and a PER preference may be generated at step 410. The station reports the QPLA parameters to the AP, which will be send as a feedback request at step 412. Otherwise, a conventional link adaptation will be used at step 408.

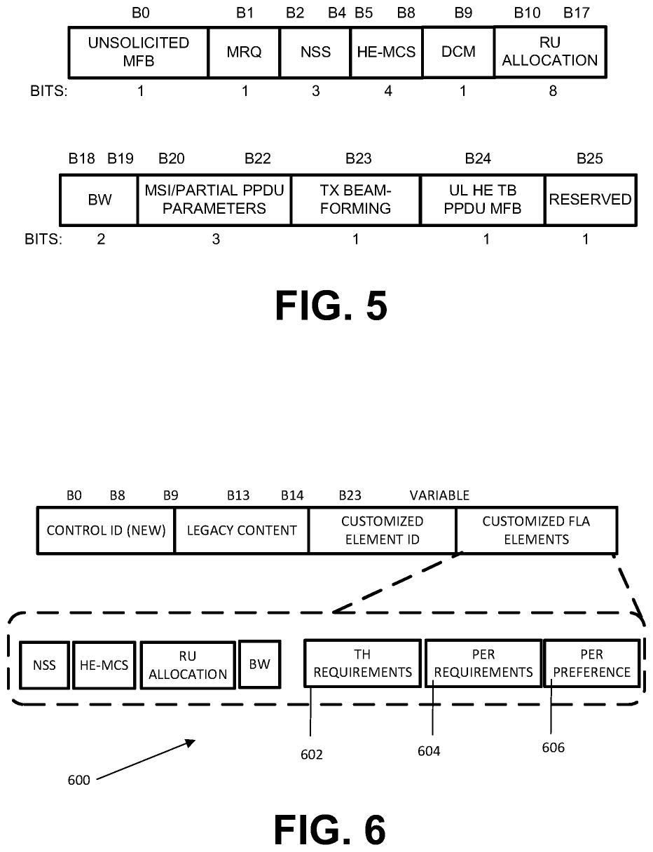

In order to provide diverse data rate and PER requirements, a new QPLA information field may be used within the high-efficiency control variant. The high-efficiency control variant may be included in M-BA. The high-efficiency control variant 600 illustrated in FIG. 6 may include three new QPLA information fields, as compared to the high-efficiency link adaptation information field shown in FIG. 5, being a data rate requirement 602, a PER requirement 604, and a PER preference 606.

The data rate requirement 602 may comprise quantified indices, which may be 8 bits in length, wherein the first 4 bits represent an amplifier value and the last 4 bits represent a base value. Specifically:

$$data rate requirement = 2 \hat{} amplifier * base * 1 Mbps .$$

The PER requirement 604 may comprise quantified indices, which may be 4 bits in length. The first 2 bits represent an amplifier value and the last 4 bits represent a base value. Specifically:

$$PER requirement = 10 \hat{} ( - amplifier - 1 ) * ( base + 1 ) * 0.2$$

The weight of the PER provisioning index or preference or indication of the priority of Data and PER requirement 606 may comprise 4 bits. Specifically:

$$Weight of PER provisioning = index / 15$$

In an exemplary embodiment using the methods and modules disclosed herein, a factory comprises one mechanical arm for manufacture, which is sensitive to PER, and one camera monitoring the manufacture process, which is sensitive to data rate. Their QoS requirements and QoS weights are presented in the following tables:

TABLE 1
QOS requirements of Mechanical Arm and Camera

| QoS Requirements | Mechanical Arm | Camera Streaming |
|---|---|---|
| PER | 0.1% | 0.1% |
| Data Rate | 5 Mbps | 15 Mbps |

TABLE 2
QoS Weights of Mechanical Arm and Camera

| QoS Weights | Mechanical Arm | Camera Streaming |
|---|---|---|
| PER | 0.7 | 0.2 |
| Data Rate | 0.3 | 0.8 |

A utility expression uₙ may be used to evaluate the satisfaction of the QoS requirements. If a QoS requirement of a station is satisfied, uₙ will add the associated utility value based on its QoS preference.

$${u}_{Arm} = 0.3 * {φ ( 1 )}_{Arm} + 0.7 * {φ ( 2 )}_{Arm}$$

$${u}_{Camera} = 0.8 * {φ ( 1 )}_{Camera} + 0.2 * {φ ( 2 )}_{Camera}$$

$$where ,$$

$${φ ( 1 )}_{Arm} = \{ \begin{matrix}1 , Data Rate \geq 5 Mbps \\ 0 , otherwise\end{matrix} ,$$

$${φ ( 2 )}_{Arm} = \{ \begin{matrix}1 , PER \leq 0.1 \% \\ 0 , otherwise\end{matrix} ,$$

$${φ ( 1 )}_{Camera} = \{ \begin{matrix}1 , Data Rate \geq 15 Mbps \\ 0 , otherwise\end{matrix} ,$$

$${φ ( 2 )}_{Camera} = \{ \begin{matrix}1 , PER \leq 0.1 \% \\ 0 , otherwise\end{matrix} ,$$

For example, PER of mechanical arm station is 0 and the data rate of mechanical arm is 4 megabits per second, u_{Arm}=0.7+0=0.7.

The following 3 link adaptation mechanisms are compared herein:
1. Conventional modulation and coding scheme based link adaptation mechanism (CMLA, implemented in Wi-Fi®: The objective is to determine the highest modulation and coding scheme to maximize data rate throughput when PER≤10%.
2. Additional PER in modulation and coding scheme based link adaptation mechanism (AMLA, implemented in 5G mechanism): The objective is to determine the highest modulation and coding scheme to maximize the data rate throughput within multiple PER constraints.
3. QoS provisioning modulation and coding scheme selection based link adaptation mechanism (QPLA): The objective is to determine the optimal modulation and coding scheme level to maximize the utility of services.

The system may generally satisfy all QoS requirements. However, when one or more channels becomes worse (as receiving signal-to-noise ratio decreases), the system may reply upon the network to support the most critical QoS requirement of each service, in order to minimize the impact on the overall manufacture process. The goal of link adaptation is to maximize the sum of utility functions uₙ.

During normal transmission (multi-user downlink, 20 MHz, 4*52 tone resource unit, signal-to-noise=33 dB), CMLA, AMLA, QPLA all select modulation and coding scheme 9 for both stations, u_{Arm}+u_{Camera}=2

| | MCS5 | MCS6 | MCS7 | MCS8 | MCS9 |
|---|---|---|---|---|---|
| PER | 0 | 0 | 0 | 0 | 0 |
| Data | 12.11 | 13.19 | 14.49 | 17.01 | 18.05 |
| Rate | Mbps | Mbps | Mbps | Mbps | Mbps |

Interference happens (multi-user downlink, 20 MHz, 4*52 tone resource units, signal-to-noise=27 dB)

| | MCS5 | MCS6 | MCS7 | MCS8 | MCS9 |
|---|---|---|---|---|---|
| PER | 0 | 0.2% | 1.7% | 3.6% | 13.1% |
| Data | 12.11 | 13.16 | 14.24 | 16.39 | 15.69 |
| Rate | Mbps | Mbps | Mbps | Mbps | Mbps |

CMLA (Wi-Fi®), selects MCS 8 for both stations,

$${u}_{Arm} + {u}_{Camera} = 0.3 + 0.8 = 1.1$$

AMLA (5G), selects MCS 5 for both stations,

$${u}_{Arm} + {u}_{Camera} = ( 0.3 + 0.7 ) + 0.2 = 1.2$$

QPLA, selects MCS 5 for mechanical arm station, MCS 8 for camera station,

$${u}_{Arm} + {u}_{Camera} = ( 0.3 + 0.7 ) + 0.8 = 1.8$$

In another exemplary embodiment of the present disclosure, co-existing QPLA and conventional high-efficiency link adaptations (HLA) are used for Wi-Fi® transmission. The first station and the second station comprise the following:
Data Rate requirement D̅R̅ₙ̅=[5, 15] Mbps
PER requirement P̅E̅R̅ₙ̅=[0.1%, 0.1%]
Weights of PER βₙ=[0.7, 0.2]

A third station does not have QPLA parameters. The AP initializes the downlink transmission process by soliciting the HLA/QPLA parameter. The first station and the second provide feedback QPLA in a control field. The third station feedbacks conventional HLA information field in a control field.

For the first station feedback: data rate requirement D̅R̅ₙ̅=5 Mbps, PER requirement=0.1%, preference of PER=0.7, the QPLA frame includes:
Data Rate requirements subfield=00000101
PER Rate requirements subfield=1111
Preference of PER subfield=1011

For the second station feedback: data rate requirement D̅R̅ₙ̅=15 Mbps, PER requirement=0.1%, Preference of PER=0.2, the QPLA frame includes:
Data Rate requirements subfield=00001111
PER Rate requirements subfield=1111
Preference of PER subfield=1011

Upon receiving QPLA parameters from the first and second stations as well as HLA from the third station, the AP determines link adaptations according to [symbol] 1 above following the received QPLA parameters. The AP determines the maximal modulation and coding scheme level with constraint PER<10% for the third station.

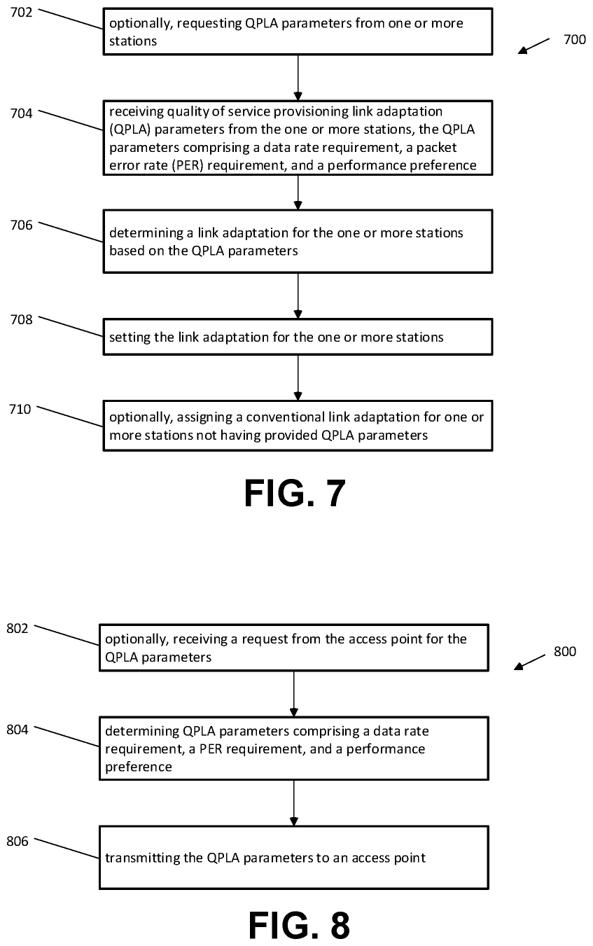

FIG. 7 is a flowchart showing steps of a method 700 performed at an AP, according to one embodiment of the present disclosure. The method 700 begins with, optionally, requesting QPLA parameters from one or more stations (step 702). At step 704, QPLA parameters are received from the one or more stations, the QPLA parameters comprising a data rate requirement, a packet error rate (PER) requirement, and a performance preference. At step 706, a link adaptation is determined for the one or more stations based on the QPLA parameters. At step 708, the link adaptation is set for one or more stations. At step 710, optionally, a conventional link adaptation is assigned for one or more stations not having provided QPLA parameters.

FIG. 8 is a flowchart showing steps of a method 800 performed by one or more stations, according to one embodiment of the present disclosure. The method 800 begins with, optionally, receiving a request from the access point for the QPLA parameters (step 802). At step 804, QPLA parameters are determined comprising a data rate requirement, a PER requirement, and a performance preference. At step 806, QPLA parameters are transmitted to an access point.

Although embodiments have been described above with reference to the accompanying drawings, those of skill in the art will appreciate that variations and modifications may be made without departing from the scope thereof as defined by the appended claims.

1. A method for link adaptation in a network system comprising an access point linked to one or more stations through one or more links, the method comprising:
receiving quality of service provisioning link adaptation (QPLA) parameters from the one or more stations, the QPLA parameters comprising a data rate requirement, a packet error rate (PER) requirement, and a performance preference;
determining a link adaptation for the one or more stations based on the QPLA parameters; and
setting the link adaptation for the one or more stations.

2. The method of claim 1 further comprising requesting the QPLA parameters from the one or more stations.

3. The method of claim 1, wherein the performance preference comprises a data rate preference and a PER preference.

4. The method of claim 1, wherein the link adaptation comprises a modulation and coding scheme and a number of space time streams.

5. The method of claim 1, further comprising assigning a conventional link adaptation for one or more stations not having provided QPLA parameters.

6. The method of claim 1, wherein the link adaptation is for a wireless local area network basic service set.

7. The method of claim 1, wherein the link adaptation is for an 802.11 protocol.

8. A method for link adaptation in a network system comprising an access point linked to one or more stations through one or more links, the method comprising:
determining QPLA parameters comprising a data rate requirement, a PER requirement, and a performance preference; and
transmitting the QPLA parameters to an access point.

9. The method of claim 8, further comprising receiving a request from the access point for the QPLA parameters.

10. The method of claim 9, wherein the performance preference comprises a data rate preference and a PER preference.

11. The method of claim 9, wherein the QPLA parameters are generated from information in a higher layer.

12. The method of claim 8, wherein the link adaptation is for a wireless local area network basic service set.

13. The method of claim 8, wherein the link adaptation is for an 802.11 protocol.

14. A module for link adaptation in a network system comprising an access point linked to one or more stations through one or more links, the module comprising:
a transceiver for sending and receiving signals from one or more stations;
a controller for:
receiving QPLA parameters from the one or more stations, the QPLA parameters comprising a data rate requirement, a PER requirement, and a performance preference;
determining a link adaptation for the one or more stations based on the QPLA parameters; and
setting the link adaptation for the one or more stations.

15. The module of claim 14 further for requesting the QPLA parameters from the one or more stations.

16. The module of claim 14, wherein the performance preference comprises a data rate preference and a PER preference.

17. The module of claim 14, wherein the link adaptation comprises a modulation and coding scheme and a number of space time streams.

18. The module of claim 14 further for assigning a conventional link adaptation for one or more stations not having provided QPLA parameters.

19. The module of claim 14, wherein the link adaptation is for a wireless local area network basic service set.

20. The module of claim 14, wherein the link adaptation is for an 802.11 protocol.
